(19) United States
(12) Patent Application Publication
(10) Pub. No.: US 2021/0334029 A1
(43) Pub. Date: Oct. 28, 2021

(54) DATA STORAGE APPARATUS AND OPERATION METHOD THEREOF

(71) Applicant: SK hynix Inc., Icheon (KR)

(72) Inventors: Yong JIN, Icheon (KR); Kwang Jin KO, Icheon (KR); Jun Hee RYU, Icheon (KR); Woo Suk CHUNG, Icheon (KR)

(21) Appl. No.: 17/070,730

(22) Filed: Oct. 14, 2020

(30) Foreign Application Priority Data
Apr. 27, 2020 (KR) 10-2020-0050851

(51) Int. Cl. G06F 3/06

(52) U.S. Cl. CPC G06F 3/0647; G06F 3/064; G06F 3/0653; G06F 3/0673; G06F 3/0656; G06F 3/0619; G06F 3/0659

(57) ABSTRACT

A data storage apparatus may include a storage including a first region and second region, each region includes a plurality of memory blocks, and a controller configured to exchange data with the storage at a request of a host. The controller may include a data classification component configured to classify attributes of data stored in the storage as hot data or cold data based on continuity of the data, and configured to move the hot data to the first region and the cold data to the second region respectively by a background operation.

### CROSS-REFERENCES TO RELATED APPLICATION

The present application claims priority under 35 U.S.C. § 119(a) to Korean application number 10-2020-0050851, filed on Apr. 27, 2020, in the Korean Intellectual Property Office, which is incorporated herein by reference in its entirety.

### BACKGROUND

### Technical Field

Various embodiments generally relate to a semiconductor integrated apparatus, and more particularly, to a data storage apparatus and an operation method thereof.

### Related Art

A data storage apparatus is connected to a host and performs a data input/output operation at a request of the host.

The data storage apparatus may use a volatile or nonvolatile memory apparatus as a storage medium.

One example of a nonvolatile memory device is a flash memory. For a flash memory device, an erase operation is typically performed before data is programmed and a program unit (page) and an erase unit (block) are different.

Accordingly, when hot data that is frequently changed and cold data that is not frequently changed are stored in substantially the same memory region (page or block), the cold data is moved to another memory region when the hot data is updated.

Flash memory devices have a limited life, that is, a limited number of program and erase operations that can be performed, so the life of the flash memory may depend on the frequency of data movement.

### SUMMARY

In an embodiment, a data storage apparatus may include: a storage including a first region and second region, each region includes a plurality of memory blocks; and a controller configured to exchange data with the storage at a request of a host. The controller may include: a data classification component configured to classify attributes of data stored in the storage as hot data or cold data based on continuity of the data, and configured to move the hot data to the first region and the cold data to the second region respectively by a background operation.

In an embodiment, an method of operating a data storage apparatus including a storage having a first region and second region, which of each region includes a plurality of memory blocks and a controller configured to exchange data with the storage, the method comprising: a step in which the controller selects a victim block which has data to be moved in the storage; a step in which the controller determines a cause of data movement; a step in which the controller determines continuity of the data to be moved; a step in which the controller classifies attributes of the data to be moved as hot data or cold data based on the cause of the data movement and the continuity; and a step of moving the hot data to the first region and the cold data to the second region respectively by a background operation.

### BRIEF DESCRIPTION OF THE DRAWINGS

FIG. 1 is a diagram of a data storage apparatus in accordance with an embodiment.

FIG. 2 is a diagram of a controller in accordance with an embodiment.

FIG. 3 is a diagram of a data classification component in accordance with an embodiment.

FIG. 4 is a flowchart of operations of a data storage apparatus in accordance with an embodiment.

FIG. 5 is a diagram that illustrates data classification of a data storage apparatus in accordance with an embodiment.

FIG. 6 is a flowchart of operations of a data storage apparatus in accordance with an embodiment.

FIG. 7 is a diagram illustrating a data storage system in accordance with an embodiment.

FIG. 8 and FIG. 9 are diagrams illustrating a data processing system in accordance with an embodiment.

FIG. 10 is a diagram illustrating a network system including a data storage device in accordance with an embodiment.

FIG. 11 is a block diagram illustrating a nonvolatile memory device included in a data storage device in accordance with an embodiment.

### DETAILED DESCRIPTION

Hereinafter, embodiments of the present technology will be described in more detail with reference to the accompanying drawings.

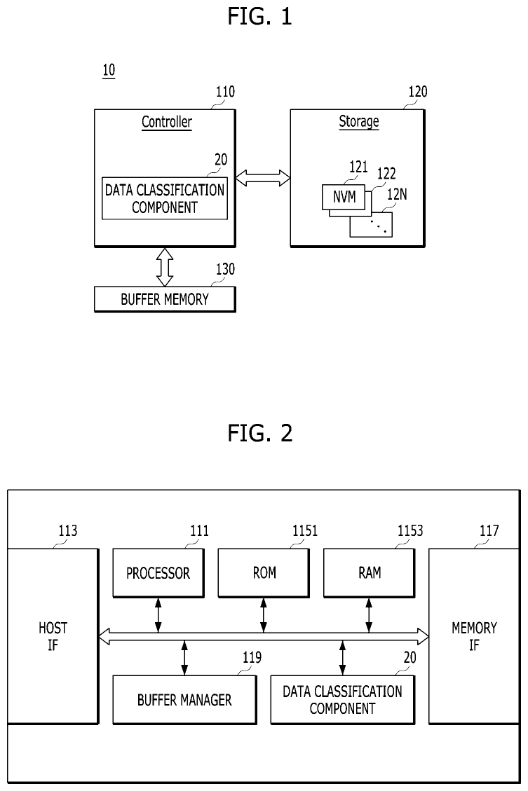

FIG. 1 is a diagram of a data storage apparatus 10 in accordance with an embodiment.

Referring to FIG. 1, the data storage apparatus 10 in accordance with an embodiment may include a controller 110, a storage 120, and a buffer memory 130.

The controller 110 may control the storage 120 in response to a request of a host. For example, the controller 110 may allow data to be programmed in the storage 120 at a write request of the host. Furthermore, the controller 110 may provide the host with the data written in the storage 120 in response to a read request of the host.

The storage 120 may write data or output the written data under the control of the controller 110. The storage 120 may include a volatile or nonvolatile memory apparatus. In an embodiment, the storage 120 may be implemented using a memory element selected from various nonvolatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM).

The storage 120 may include a plurality of nonvolatile memories (NVM) 121 to 12N, and each of the plurality of nonvolatile memories 121 to 12N may include a plurality of dies, a plurality of chips, or a plurality of packages. In addition, the storage 120 may operate as a single-level cell that stores one-bit data in one memory cell or a multi-level cell that stores multi-bit data in one memory cell.

The buffer memory 130 serves as a space capable of temporarily storing data when the data storage apparatus 10 performs a series of operations of writing or reading data in cooperation with the host. Although FIG. 1 illustrates an embodiment in which the buffer memory 130 is provided outside the controller 110, in another embodiment, the buffer memory 130 may be provided inside the controller 110.

The controller 110 in accordance with an embodiment of the present technology may include a data classification component 20.

The data classification component 20 may be configured to, when data is moved in the storage 120 by an internal operation of the data storage apparatus 10 such as a background operation, classify the data as hot data or cold data based on the cause of the data movement and the characteristics of the moved data, and to move the hot data and the cold data to physically separated regions. Here, the cause of the data movement refers to an operation associated with the data movement, such as a type of housekeeping operation, examples of which are provided below. Accordingly, embodiments of the present application may perform different processes based on the particular operation associated with accessing memory.

In an embodiment, the data classification component 20 may separately manage a logical address of data classified as cold data.

When the host requests writing data that has a logical address classified as cold data, the data classification component 20 may store the write-requested data in a cold data storage region. When the host requests reading data that has a logical address classified as cold data, the data classification component 20 may cache the read-requested data in the buffer memory 130 and prefetch (read ahead) data which corresponds to a logical address subsequent to the read-requested logical address in the buffer memory 130. In addition, when the read frequency of the read-requested cold data is equal to or more than a predetermined threshold value, the data classification component 20 may substantially maintain the read data and/or the prefetched read data in the buffer memory 130.

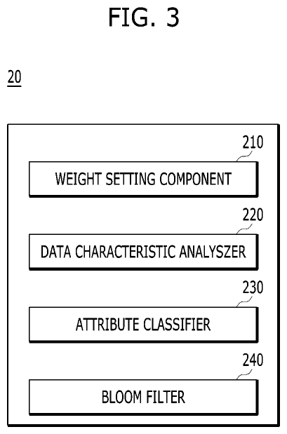

FIG. 2 is a diagram of the controller 110 in accordance with an embodiment.

Referring to FIG. 2, a controller 110 in accordance with an embodiment may include a processor 111, a host interface (IF) 113, a ROM 1151, a RAM 1153, a memory interface (IF) 117, a buffer manager 119, and the data classification component 20.

The processor 111 may be configured to transfer various types of control information that is used for a data read or write operation for the storage 120 to the host IF 113, the RAM 1153, the memory IF 117, and the buffer manager 119. In an embodiment, the processor 111 may operate according to firmware provided for various operations of the data storage apparatus 10. In an embodiment, the processor 111 may perform a function of a flash translation layer (FTL) for performing address mapping and a housekeeping operation for managing the storage 120, a function of detecting and correcting an error of data read from the storage 120, and the like.

In an embodiment, the housekeeping operation may be an operation such as garbage collection (GC), wear leveling (WL), read reclaim (RR), background media scan (BGMS), and the like.

In a flash memory apparatus, in order to update data corresponding to some pages of a memory block, the data requested to be updated is read and updated, the updated data is written in a free block, and a page storing data before being updated is invalidated. Garbage collection refers to an operation of arranging valid data in a block that includes one or more invalidated pages and providing a number of free blocks. In order to perform garbage collection, a victim block that includes invalid pages may be selected, valid data in the victim block may be copied to a free block, and then the victim block may be erased and converted into a free block.

Wear leveling refers to an operation of uniformly managing the number of uses (programs and erases) of a memory block as a whole. In order to perform wear leveling, data of a victim block with a smaller number of uses may be moved to a block with a larger number of uses.

The error level of data stored in a flash memory block gradually increases for various reasons such as read disturb and charge leakage. Read reclaim refers to an operation of moving data of a victim block to another memory block to prevent errors. For example, a read reclaim operation may be performed before a level of errors in a memory block reaches a predetermined level.

A background media scan is an operation of reading data of a memory block at a preset cycle in order to check data retention and moving data of a victim block with poor retention characteristics to another memory block.

In the following description, a block may refer to a memory region including a plurality of pages or a block group including a plurality of memory blocks.

The host IF 113 may provide a communication channel for receiving a command and a clock signal from the host and controlling data input/output under the control of the processor 111. In particular, the host IF 113 may provide a physical connection between the host and the data storage apparatus 10. Furthermore, the host IF 113 may interface with the data storage apparatus 10 according to a bus format of the host. The bus format of the host may include at least one standard interface protocol such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-E), and a universal flash storage (UFS).

The ROM 1151 may store program codes required for the operation of the controller 110, for example, firmware or software, and store code data and the like used by the program codes.

The RAM 1153 may store data required for the operation of the controller 110 or data generated by the controller 110.

The memory IF 117 may provide a communication channel for signal transmission/reception between the controller 110 and the storage 120. The memory IF 117 may write data, which has been temporarily stored in the buffer memory 130, in the storage 120 under the control of the processor 111. Furthermore, the memory IF 117 may transfer data read from the storage 120 to the buffer memory 130 for temporary storage.

The buffer manager 119 may be configured to manage the use state of each buffer memory 130. In an embodiment, the buffer manager 119 may divide the buffer memory 130 into a plurality of regions (slots) and allocate or release each region in order to temporarily store data.

In an embodiment, the buffer manager 119 may release a buffer region (slot), where completely programmed data is cached, in response to a program completion signal transmitted from the storage 120. Furthermore, the buffer manager 119 may allocate the released buffer region to store new data provided from the host. In an embodiment, the buffer manager 119 may cache data read from the storage 120 in the buffer memory 130, and release or substantially maintain a buffer region (slot) where data transmitted to the host is cached.

The data classification component 20 may be configured to, when data is moved in the storage 120 by the housekeeping operation of the processor 111, classify the attributes of data included in a victim block into hot data or cold data based on the cause of the data movement and the characteristics of the moved data, for example, an amount of continuity or discontinuity, and to move the hot data and the cold data to physically separated regions.

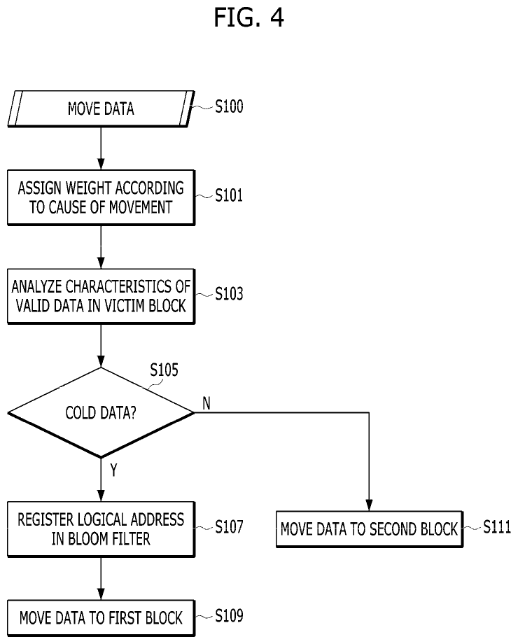

FIG. 3 is a diagram of the data classification component 20 in accordance with an embodiment.

Referring to FIG. 3, the data classification component 20 may include a weight setting component 210, a data characteristic analyzer 220, an attribute classifier 230, and a bloom filter 240. The bloom filter is a probabilistic data structure that may be used to test whether a specific element belongs to a set.

In an embodiment, the weight setting component 210 may set a weight according to the type of housekeeping operation that is being performed, that is, the cause of data movement such as GC, WL, RR, or BGMS, and assign the weight to a victim block selected for the data movement. When the cause of the data movement is read reclaim due to read disturbance, the risk of disturbance for a corresponding block may be managed as meta data.

The data characteristic analyzer 220 may analyze the continuity of data to be moved based on a logical address of valid data included in the selected victim block, and in particular, analyze whether the data is sequential data or random data. In order to determine the continuity of the data to be moved, the data characteristic analyzer 220 may consider at least one of a distribution of logical addresses of the valid data included in the victim block, sizes of data chunks, and a distribution of the sizes of the data chunks. In an embodiment, distribution is expressed as variance.

The attribute classifier 230 may classify the data in the victim block as hot data or cold data based on the weights and the degree of continuity or discontinuity present in the data. In an embodiment, the attribute classifier 230 may classify attributes in units of all valid data in the victim block according to a result of the continuity analysis of the data in the victim block, or classify the data as hot data or cold data in units of individual data or data chunks in the victim block.

In an embodiment, the bloom filter 240 may register a logical address of the data classified as cold data, or a range of logical addresses.

As the data in the victim block is classified as hot or cold data, the memory IF 117 may move the cold data to a first block and the hot data to a second block, thereby distinguishing them. To this end, the storage 120 may be managed as comprising a cold data region including the first block and a hot data region including the second block; however, the present disclosure is not limited to this embodiment.

When the check results of the bloom filter 240 indicate that a logical address included in a write request of the host is included in a logical address (range) of the cold data, the memory IF 117 may store data in the first block or the cold data region. In addition, when the check results of the bloom filter 240 indicate that a logical address included in a read request of the host is present in the previously registered logical address range associated with cold data, the memory IF 117 may read data from the first block or the cold data region. At this time, the memory IF 117 may prefetch read-requested cold data and data which corresponds to a logical address subsequent to a read-requested logical address in the buffer memory 130. In addition, when the read-requested cold data is a read disturbance risk block, the processor 111 may substantially maintain some or all of the read data and/or the prefetched read data in the buffer memory 130.

At least one victim block selected for housekeeping may include at least one page storing valid data, and each page may be managed according to a logical address and a physical address corresponding to the logical address. Data stored in a plurality of pages assigned a continuous logical address may constitute a data chunk.

As a victim block to be moved is selected, the data characteristic analyzer 220 of the data classification component 20 may extract the number of valid pages included in the victim block and a logical address of each valid page. Based on a difference between a maximum value and a minimum value of the extracted logical address, or range of logical addresses, when the range of the logical addresses is equal to or less than a first threshold value, the data characteristic analyzer 220 may determine that the data as sequential data, and when the range of the logical addresses is larger than the first threshold value, the data characteristic analyzer 220 may determine the data as random data. The sequential data may be, for example, large-capacity cold data such as media contents and the random data may be hot data that is frequently updated. In addition, based on a distribution of logical addresses of the valid page, for example, a variance, when the variance is equal to or less than a second threshold value, the data characteristic analyzer 220 may determine the data as sequential data, and when the variance is larger than the second threshold, the data characteristic analyzer 220 may determine the data as random data. Accordingly, it is possible to classify attributes in units of all valid data included in the victim block.

In an embodiment, the data characteristic analyzer 220 may further determine the sizes of respective data chunks in the victim block and a distribution of the sizes of respective data chunks. In order to confirm the sizes of the data chunks, the number of pages in which logical addresses are continuous and the size per unit page may be used. For example, the sizes of the data chunks and the distribution of the sizes of the data chunks may be calculated by multiplying the size of the unit page by the number of pages in which the logical addresses are continuous. When the size of the data chunk is equal to or more than a third threshold value, the data characteristic analyzer 220 may determine the data as sequential data, and when the size of the data chunk is smaller than the third threshold value, the data characteristic analyzer 220 may determine the data as random data. By so doing, it is possible to classify attributes in units of individual data in the victim block. In addition, it is also possible to classify attributes in units of all valid data in the victim block according to the distribution of the sizes of the data chunks in the victim block.

In a flash memory apparatus, some data changes very infrequently, and such data is referred to as cold or static data. On the other hand, data that changes very frequently is referred to as hot or dynamic data. When a first part of a page constituting one block has cold data and a second part has hot data, the cold data is moved together when the hot data is moved during a housekeeping operation such as wear leveling. Since this may cause a problem such as write amplification, embodiments of the present application may separately store the cold data and the hot data in different blocks or regions.

Since the frequency at which data is changed is determined at an application program level, it is difficult for the controller 110 to predict the attributes of data stored in one block.

According to the present technology, data may be classified as hot data and cold data based on the cause of data movement and the continuity of valid data in a victim block selected for the data movement, and the hot data and the cold data may be separately stored in separate regions.

The cold data is highly likely to be deleted in the future, and such cold data may be collected as much as possible and deleted by a single operation, thereby substantially preventing fragmentation of the storage. Furthermore, when reading sequential cold data, it is possible to improve read latency by prefetching data predicted to be the subject of a subsequent read-request. In addition, when reading cold data registered as a read disturbance risk block, it is possible to reduce the frequency of access to the read disturbance risk block by keeping the cold data cached in the buffer memory.

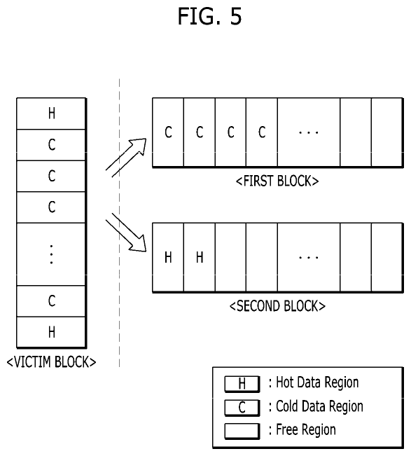

FIG. 4 is a flowchart that illustrates operations of the data storage apparatus in accordance with an embodiment.

Referring to FIG. 4, when data movement occurs in the storage 120 by a housekeeping operation of the data storage apparatus 10 (S100), the controller 110 may assign a weight to a victim block selected according to the type of housekeeping operation, that is, the cause such as GC, WL, RR, or BGMS of the data movement (S101). When the cause of the data movement is read reclaim due to read disturbance, the risk of disturbance for a corresponding block may be managed as meta data.

The controller 110 may analyze the continuity of data to be moved based on a logical address of valid data included in the selected victim block, that is, analyze whether the data is sequential data or random data (S103). In order to determine the continuity of the data to be moved, the controller 110 may consider at least one of a distribution of logical addresses of the valid data included in the victim block, sizes of data chunks, and a distribution of the sizes of the data chunks.

In an embodiment, the controller 110 may extract the number of valid pages included in the victim block to be moved and a logical address of each valid page.

Based on a difference between a maximum value and a minimum value of the extracted logical address, that is, the range of the logical addresses, when the range of the logical addresses is equal to or less than the first threshold value, the controller 110 may determine the data as sequential data, and when the range of the logical addresses is larger than the first threshold value, the controller 110 may determine the data as random data.

Based on a distribution of logical addresses of the valid page, for example, a variance derived from an average of the logical addresses, when the variance is equal to or less than the second threshold value, the controller 110 may determine the data as sequential data, and when the variance is larger than the second threshold value, the controller 110 may determine the data as random data. By so doing, it is possible to classify attributes in units of all valid data included in the victim block.

The controller 110 may further determine the sizes of respective data chunks in the victim block and a distribution of the sizes. In an embodiment, the sizes of the data chunks and the distribution of the sizes of the data chunks may be calculated by multiplying the size per unit page by the number of pages in which the logical addresses are continuous. When the size of the data chunk is equal to or more than the third threshold value, the controller 110 may determine the data as sequential data, and when the size of the data chunk is smaller than the third threshold value, the controller 110 may determine the data as random data. By so doing, it is possible to classify attributes in units of individual data in the victim block. In addition, it is also possible to classify attributes in units of all valid data in the victim block according to the distribution of the data chunks in the victim block. In an embodiment, all data in a corresponding victim block, in which a distribution of chunk sizes is smaller than a fourth threshold value, may be classified into cold data.

The controller 110 may classify the data in the victim block as hot data or the cold data based on the weights and the degree of continuity or discontinuity (S105). In an embodiment, the controller 110 may classify attributes in units of all valid data in the victim block according to a result of the continuity analysis of the data in the victim block, or classify the data as hot data or cold data in units of individual data or data chunks in the victim block.

The controller 110 may register a logical address of the data classified into the cold data or a range of the logical addresses in the bloom filter 240 (S107), and move the data classified into the cold data to the first block or the cold data region of the storage 120 (S109). The controller 110 may move the data classified as hot data to the second block or the hot data region of the storage 120 (S111).

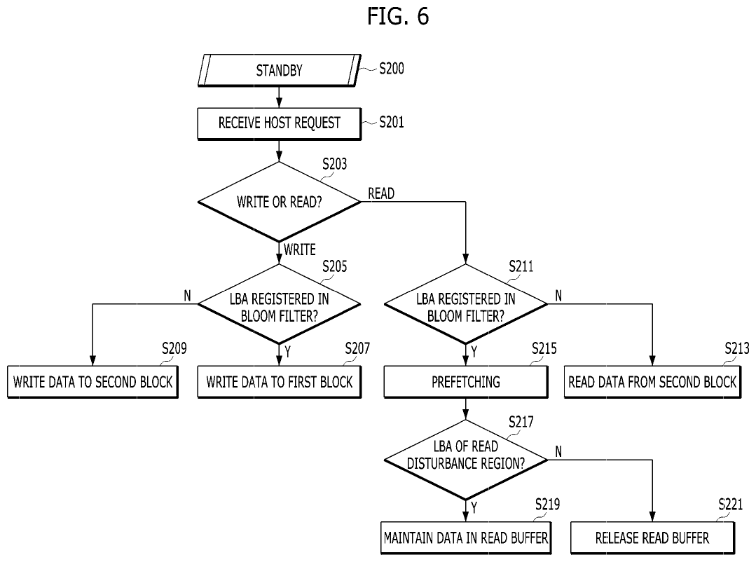

FIG. 5 that illustrates data classification of the data storage apparatus in accordance with an embodiment.

Referring to FIG. 5, hot data H and cold data C may be classified in units of individual data of a victim block, the cold data C may be collected in the first block, and the hot data H may be collected in the second block. As such a classification process is repeated through housekeeping operations, cold data may be continuously accumulated in the first block and hot data may be continuously accumulated in the second block, so that the life of the storage 120 may be more easily managed.

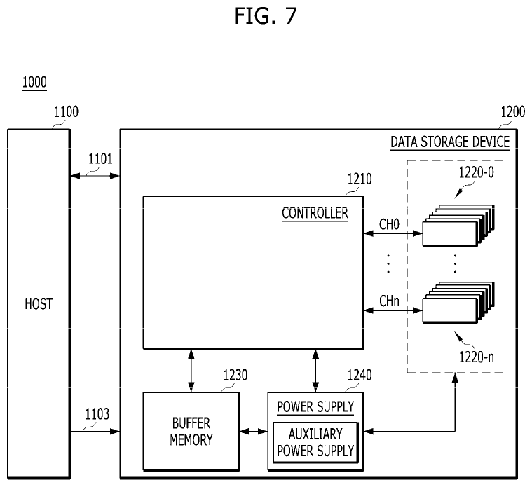

FIG. 6 is a flowchart of operations of a data storage apparatus in accordance with an embodiment.

In a standby state (S200), the controller 110 may receive a request of the host (S201) and determine the type of the request (S203).

When the host requests data write (S203: write), the controller 110 may confirm whether a logical address included in the write request is included in the range of logical addresses registered in the bloom filter 240 (S205).

When the logical address included in the write request is included in (the range of) the logical addresses of cold data (S205: Y), the controller 110 may generate mapping information such that data is stored in the first block or the cold data region and transmit a write command to the storage 120 (S207). When the logical address included in the write request is not included in (the range of) the logical addresses of the cold data (S205: N), the controller 110 may generate mapping information such that data is stored in the second block or the hot data region and transmit a write command to the storage 120 (S209).

Meanwhile, when the host transmits a read request (S203: read), the controller 110 may confirm whether a logical address included in the read request is included in the range of the logical addresses registered in the bloom filter 240 (S211).

When the logical address included in the read request is not included in (the range of) the logical addresses of the cold data (S211: N), the controller 110 may read data from the second block or the hot data region and provide the data to the host (S213).

When the logical address included in the read request is included in (the range of) the logical addresses of the cold data (S211: Y), the controller 110 may read data from the first block or the cold data region. At this time, the controller 110 may prefetch the read-requested cold data and data which corresponds to a logical address subsequent to the read-requested logical address, in the buffer memory 130 (S215). In addition, the controller 110 may confirm with reference to meta data whether the read-requested cold data is a read disturbance risk block (S217), and substantially maintain the read data and/or prefetched read data in the buffer memory 130 (S219) when the read-requested cold data is present in the read disturbance risk block (S217: Y). When the read-requested cold data is not in the read disturbance risk block (S217: N), the controller 110 may release a buffer memory allocated to cache the read data (S221).

According to the present technology, it is possible to substantially prevent unnecessary data movement by separately storing hot data, which is frequently updated, and cold data.

Furthermore, it is possible to improve a read speed and read disturbance characteristics by prefetching and/or caching read-requested cold data and data having continuity with the read-requested data.

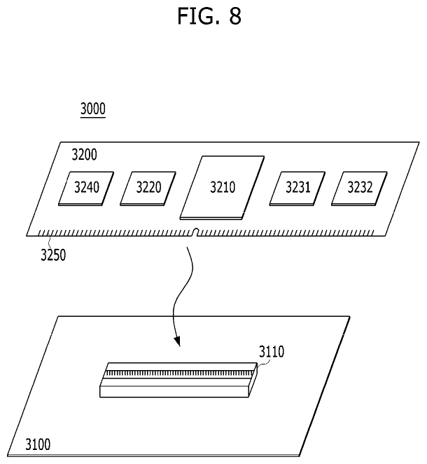

FIG. 7 is a diagram illustrating a data storage system 1000, in accordance with an embodiment.

Referring to FIG. 7, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface unit, a control unit, a random access memory used as a working memory, an error correction code (ECC) unit, and a memory interface unit. In an embodiment, the controller 1210 may configured as controller 110 shown in FIGS. 1 and 2.

The host device 1100 may exchange a signal with the data storage device 1200 through the signal connector 1101. The signal may include a command, an address, data, and so forth.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be normally terminated when a sudden power interruption occurs. The auxiliary power supply may include bulk-capacity capacitors sufficient to store the needed charge.

The signal connector 1101 may be configured as one or more of various types of connectors depending on an interface scheme between the host device 1100 and the data storage device 1200.

The power connector 1103 may be configured as one or more of various types of connectors depending on a power supply scheme of the host device 1100.

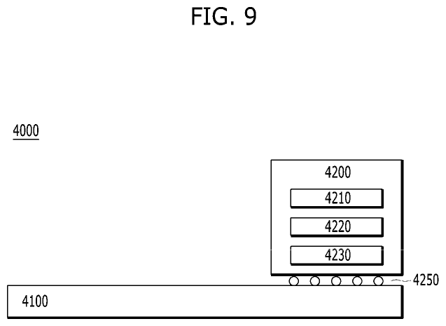

FIG. 8 is a diagram illustrating a data processing system 3000, in accordance with an embodiment. Referring to FIG. 8, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 and 2.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and so forth, and power may be transferred between the host device 3100 and the memory system 3200. The connection terminal 3250 may be configured as one or more of various types depending on an interface scheme between the host device 3100 and the memory system 3200. The connection terminal 3250 may be disposed on a side of the memory system 3200, as shown.

FIG. 9 is a diagram illustrating a data processing system 4000 in accordance with an embodiment. Referring to FIG. 9, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 and 2.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

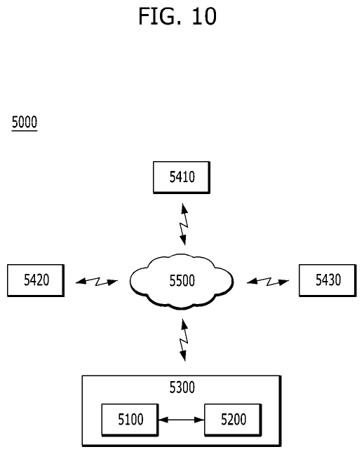

FIG. 10 is a diagram illustrating a network system 5000 including a data storage device, in accordance with an embodiment. Referring to FIG. 10, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 7, the memory system 3200 shown in FIG. 8, or the memory system 4200 shown in FIG. 9.

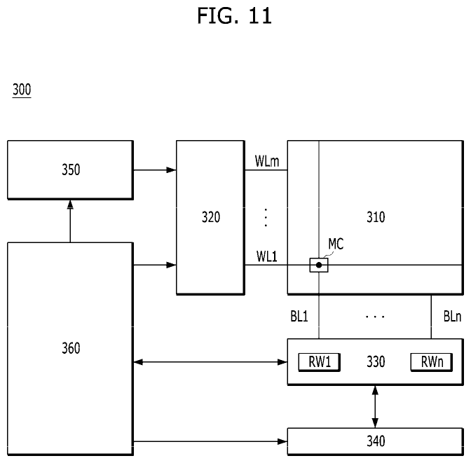

FIG. 11 is a block diagram illustrating a nonvolatile memory device 300 included in a data storage device, such as the data storage device 10, in accordance with an embodiment. Referring to FIG. 11, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array, for example, has a stacked structure by perpendicular direction to the flat surface of a semiconductor substrate. Moreover, the three-dimensional memory array means a structure including NAND strings which memory cells comprised in NAND strings are stacked perpendicular to the flat surface of a semiconductor substrate.

The structure of the three-dimensional memory array is not limited to the embodiment indicated above. The memory array structure can be formed in a highly integrated manner with horizontal directionality as well as vertical directionality. In an embodiment, in the NAND strings of the three-dimensional memory array memory cells are arranged in the horizontal and vertical directions with respect to the surface of the semiconductor substrate. The memory cells may be variously spaced to provide different degrees of integration

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided by the external device. For example, the control logic 360 may control operations of the nonvolatile memory device 300 such as read, write, and erase operations of the nonvolatile memory device 300.

The above described embodiments are intended to illustrate and not to limit the present disclosure. Various alternatives and equivalents are possible. The scope of the technology is not limited by the embodiments described herein. Nor is the technology limited to any specific type of semiconductor device. Other additions, subtractions, or modifications are obvious in view of the present disclosure and are intended to fall within the scope of the appended claims.

What is claimed is:

1. A data storage apparatus comprising:
a storage including a first region and second region, each region including a plurality of memory blocks; and
a controller configured to exchange data with the storage,
wherein the controller comprises:
a data classification component configured to classify attributes of data stored in the storage as hot data or cold data based on continuity of the data, and configured to move the hot data to the first region and the cold data to the second region respectively by a background operation.

2. The data storage apparatus according to claim 1, wherein the controller is configured to determine the continuity based on at least one of a distribution of logical addresses of valid data included in a victim block to be moved, sizes of data chunks, and a distribution of the sizes of the data chunks.

3. The data storage apparatus according to claim 1, wherein the controller is configured to classify attributes of data stored in the storage further based on a cause of the data movement, and to classify the attributes in units of all valid data included in a victim block to be moved, or to classify the attributes in units of individual data in the victim block.

4. The data storage apparatus according to claim 1, wherein the controller is configured to extract a logical address of each valid data included in a victim block to be moved, and to determine all data in the victim block as cold data according to a determination that a difference between a maximum value and a minimum value of the extracted logical addresses is equal to or less than a first threshold value.

5. The data storage apparatus according to claim 1, wherein the controller is configured to extract the logical address of each valid data included in a victim block to be moved, and to determine all the data in the victim block as cold data according to a determination that a distribution of the extracted logical addresses is equal to or less than a second threshold value.

6. The data storage apparatus according to claim 1, wherein the controller is configured to determine all the data in a victim block as cold data according to a determination that a size of each valid data chunk included in the victim block to be moved is equal to or more than a third threshold value.

7. The data storage apparatus according to claim 1, wherein the controller is configured to calculate a size of each valid data chunk included in a victim block to be moved, and to determine data, in which the size of each chunk is equal to or more than the third threshold value, as cold data according to a determination that a distribution of the sizes of the data chunks is smaller than a fourth threshold value.

8. The data storage apparatus according to claim 1, wherein the controller further comprises:
a bloom filter configured to register a logical address of the data classified as cold data.

9. The data storage apparatus according to claim 8, wherein a first region and second region are configured as physically separated regions, and
the controller is configured to store the write-requested data in the second region according to a determination that a logical address of data write-requested by the host is registered in the bloom filter.

10. The data storage apparatus according to claim 8, further comprising:
a buffer memory configured to temporarily store data read from the storage,
wherein the controller is configured to prefetch data read from the second region, and data which corresponds to a logical address subsequent to the read-requested logical address, in the buffer memory according to a determination that a logical address of data read-requested by the host is registered in the bloom filter.

11. A method of operating a data storage apparatus including a storage having a first region and second region, each region including a plurality of memory blocks and a controller configured to exchange data with the storage, the method comprising:
a step in which the controller selects a victim block which has data to be moved in the storage;
a step in which the controller determines continuity of the data to be moved;
a step in which the controller classifies attributes of the data to be moved as hot data or cold data based on the cause of the data movement and the continuity; and
a step of moving the hot data to the first region and the cold data to the second region respectively by a background operation.

12. The method according to claim 11, wherein the step of determining the continuity comprises:
determining the continuity based on at least one of a distribution of logical addresses of valid data included in the victim block, sizes of data chunks, and a distribution of the sizes of the data chunks.

13. The method according to claim 11, further comprising a step of determining a cause of data movement;
wherein the step of classifying the attributes comprises:
classifying the attributes in units of all valid data included in the victim block, or classifying the attributes in units of individual data in the victim block.

14. The method according to claim 11, wherein the step of classifying the attributes comprises:
extracting a logical address of each valid data included in the victim block; and
determining all data in the victim block as cold data according to a determination that a difference between a maximum value and a minimum value of the extracted logical addresses is equal to or less than a first threshold value.

15. The method according to claim 11, wherein the step of classifying the attributes comprises:
extracting the logical address of each valid data included in the victim block; and
determining all the data in the victim block as cold data according to a determination that a distribution of the logical addresses is equal to or less than a second threshold value.

16. The method according to claim 11, wherein the step of classifying the attributes comprises:
determining all the data in the victim block as cold data according to a determination that a size of each valid data chunk included in the victim block is equal to or more than a third threshold value.

17. The method according to claim 11, wherein the step of classifying the attributes comprises:
calculating a size of each valid data chunk included in the victim block; and
determining data, in which the size of each chunk is equal to or more than the third threshold value, as cold data according to a determination that a distribution of the sizes of the data chunks is smaller than a fourth threshold value.

18. The method according to claim 11, further comprising a step of:
registering a logical address of the data classified as cold data in a bloom filter.

19. The method according to claim 18, wherein a first region and second region are configured as physically separated regions, and
wherein the operation method further comprises a step in which the controller stores the write-requested data in the second region according to a determination that a logical address of data write-requested by the host is registered in the bloom filter.

20. The method according to claim 18, wherein the data storage apparatus further comprises:
a buffer memory configured to temporarily store data read from the storage, and
the operation method further comprises a step in which the controller prefetches data read from the second region and data, which corresponds to a logical address subsequent to the read-requested logical address, in the buffer memory according to a determination that a logical address of data read-requested by the host is registered in the bloom filter.
